(19) United States
(12) Patent Application Publication
(10) Pub. No.: US 2017/0218995 A1
(43) Pub. Date: Aug. 3, 2017

(54) CORNER PIECE FOR ATTACHING TWO PROFILES AT AN ANGLE, PROFILE, SET, CORNER ELEMENT, FRAME, STAND CONSTRUCTION ELEMENT, STAND AND METHOD AND DEVICE FOR MAKING THEREOF

(71) Applicant: ALUVISION, DEINZE (BE)

(72) Inventor: MICHIEL LESAGE, DEINZE (BE)

(21) Appl. No.: 15/307,554

(22) PCT Filed: Apr. 29, 2015
(86) PCT No.: PCT/BE2015/053115

§ 371 Date: Oct. 28, 2016

(30) Foreign Application Priority Data
Apr. 29, 2014 (BE) 2014/0298

(51) Int. Cl. F16B 12/50; A47F 5/10

(52) U.S. Cl. CPC F16B 12/50; A47F 5/10; F16B 2012/505

(57) ABSTRACT

A corner piece for mounting two profiles at an angle, the corner piece comprising at least a first and a second leg mounted mounted together at an angle to each other, wherein the first leg is arranged to be slid into a mounting channel of a first profile along the first direction and the second leg is arranged to be slid into a mounting channel of a second profile along the second direction, characterized in that at least the first leg comprises at least one protrusion extending along a height direction of the mounting channel, so that when sliding the first leg into the mounting channel of the first profile, the protrusion clamps the first leg into a predetermined position in the mounting channel of the first profile.

### BACKGROUND OF THE INVENTION

For the construction of stands, e.g. promotion booths, as used at trade shows, exhibitions, events etc., use is often made of frames, which in this case are also known as stand construction elements, often comprising corner elements which in turn are composed of profiles and associated connecting elements. Panels, curtains, lighting and other decorations, for instance, are then affixed to the frames that make up the stand.

As the connecting element for forming the corner element, a corner piece is often used. Such a corner piece thus serves for mounting two profiles at an angle. The corner piece thereto comprises at least a first and a second leg. The first and the second leg are mounted together at an angle to each other. The first leg extends along a first direction and the second leg extends along a second direction. The first leg is arranged to be slid into a mounting channel of a first profile along the first direction and the second leg is arranged to be slid into a mounting channel of a second profile along the second direction. By means of such a corner piece, a corner element can be made from two profiles, to be used in a frame, e.g. by mounting two corner elements together using two additional corner pieces, for a stand construction element for a stand.

The corner piece, more specifically the first and the second leg of the corner piece, is commonly glued into the profiles, more specifically into the mounting channels into which the legs have been slid, thus preventing the corner piece from exiting the profiles and severing the connection between the profiles of the corner element.

### BRIEF SUMMARY OF THE INVENTION

The invention relates to a corner piece as described in the preamble of the first claim. The invention also relates to:

a profile,

a set comprising the corner piece and at least two profiles,

a corner element comprising at least two profiles, connected at an angle by means of the corner piece,

a frame comprising the corner element,

a stand construction element wherein the stand construction element is the frame,

a stand comprising the stand construction element,

a method for manufacturing the corner element, and

a device for implementing said method.

According to embodiments of the present invention, the protrusion slopes downward in the first direction. A protrusion presenting such a shape offers the advantage that when sliding the first leg into the mounting channel of the first profile, an improved clamping of the first leg in the mounting channel is gradually achieved. It was found that such clamping can be achieved more easily.

According to embodiments of the present invention, the protrusion presents a triangular cross section. It was found that such a cross section for a protrusion can be achieved more easily, for instance by folding over part of the material of the first leg. Moreover, it was found that a protrusion with such a cross section also presents good clamping properties. Without being bound to any theory, it can be said that a triangular cross section of this kind presents an asymmetry which on the one hand facilitates the insertion of the leg provided with said protrusion into its corresponding mounting channel, while on the other hand hampering the removal of the leg from the mounting channel.

According to embodiments of the present invention, the first leg is substantially flat and is delimited in its width direction by at least two opposing edges defining the length direction of the first leg and extending along the first direction, wherein the protrusion extends in the height direction of the first leg. It was found that a first leg with such a shape is easier to manufacture, for instance by providing the first leg in sheet form by cutting, stamping, punching, etc. the first leg from a sheet material.

According to embodiments of the present invention, the first leg of the corner piece, preferably the entire corner piece, is made from a metal, preferably steel. It was found that the use of steel allows the material of the corner piece, and especially the material of the protrusion, to acquire resilient properties, yielding a further improvement of the attachment of the legs in profiles.

According to embodiments of the present invention, the protrusion extends from one of the edges of the first leg. Since the material of the first leg can be folded away relatively easily at the edge of the material, especially when the material of the first leg is metal, especially steel, it was found that a protrusion of this kind can be manufactured with relative ease. Moreover, it was found that, since the mounting channel of the first profile into which the first leg will be received often does not completely surround the first leg, yet often at least surrounds the edges of the first leg, a protrusion extending from one of the edges of the first leg will allow the first leg to be clamped inside the mounting channel even in such a configuration.

According to embodiments of the present invention, the corner piece comprises at least one subsequent protrusion. Providing subsequent protrusions on the corner piece allows a further improved clamping of the corner piece inside the profiles, allowing a further improved anchoring of the corner piece in the profile piece.

According to embodiments of the present invention, the first leg comprises at least one subsequent protrusion. Providing subsequent protrusions on the first leg allows a further improved clamping of the first leg inside the first profile, allowing a further improved anchoring of the first leg in the first profile.

According to embodiments of the present invention, the protrusion extends from a first edge of the first leg and the subsequent protrusion extends from a second edge of the first leg, wherein the second edge of the first leg is located opposite the first edge of the first leg. It was found that in such a configuration, an anchoring in the width direction of the mounting channel is additionally achieved, allowing among other things a further improved anchoring of the first leg in the first profile. Moreover, in such a configuration, the attachment of the first leg in the first profile is also assured at opposite edges of the first leg, improving the stability of the mounting of the first leg in the first profile.

According to embodiments of the present invention, the second leg comprises at least one subsequent protrusion. Providing subsequent protrusions on the second leg also allows a clamping of the second leg inside the second profile, similar to the clamping of the first leg inside the first profile.

According to embodiments of the present invention, the second leg is substantially flat and is delimited in its width direction by at least two opposing edges defining the length direction of the second leg and extending along the second direction. It was found that a second leg with such a shape is easier to manufacture, for instance by providing the second leg in sheet form by cutting, stamping, punching, etc. the second leg from a sheet material.

According to embodiments of the present invention, the corner piece is provided in sheet form, for instance by cutting it from a sheet.

According to embodiments of the present invention, the second leg of the corner piece, preferably the entire corner piece, is made from a metal, preferably steel.

According to embodiments of the present invention, the at least one subsequent protrusion extends in the height direction of the second leg.

According to embodiments of the present invention, the at least one subsequent protrusion extends from one of the edges of the second leg. Since the material of the legs, in this case the second leg, can be folded away relatively easily at the edge of the material, especially when the material of the second leg is metal, especially steel, it was found that a protrusion of this kind can be manufactured with relative ease. Moreover, it was found that, since the mounting channel of the second profile into which the second leg will be received often does not completely surround the second leg, yet often at least surrounds the edges of the second leg, a protrusion extending from one of the edges of the second leg will allow the second leg to be clamped inside the mounting channel even in such a configuration.

According to embodiments of the present invention, the second leg comprises at least two subsequent protrusions. Providing at least two subsequent protrusions on the second leg also allows a further improved clamping of the second leg inside the second profile.

According to embodiments of the present invention, a first subsequent protrusion extends from a first edge of the second leg and a second subsequent protrusion extends from a second edge of the second leg, wherein the second edge of the second leg is located opposite the first edge of the second leg. It was found that in such a configuration, an anchoring in the width direction of the mounting channel is additionally achieved, allowing among other things a further improved anchoring of the second leg in the second profile. Moreover, in such a configuration, the attachment of the second leg in the second profile is also assured at opposite edges of the second leg, improving the stability of the mounting of the second leg in the second profile.

According to embodiments of the present invention, the first leg and/or the second leg tapers along the first and/or second direction, respectively, wherein the side facing away from the protrusion is shorter than the opposite side. For instance, the side facing away from the protrusion can be slanted with respect to the opposite side. A tapering end of this kind offers the advantage that glue applied to the side facing away from the protrusion is not pushed away, but instead is spread out over the surface facing away from the protrusion in an improved manner, allowing a better bonding to be achieved by the glue and/or allowing less glue to be used.

### BRIEF DESCRIPTION OF THE SEVERAL VIEWS OF THE DRAWINGS

The invention will be further elucidated by means of the following description and the appended figures.

FIG. 1 shows an overview of a number of profiles.

FIG. 2a shows an overview of a corner piece according to the present invention.

FIG. 2b shows a side view of the corner piece according to FIG. 2a.

FIG. 2c shows a top view of the corner piece according to FIG. 2a.

FIG. 3 shows an overview of a number of profiles provided with a number of corner pieces according to the present invention.

FIG. 4 shows a detail of figure3.

FIG. 5 shows a detail of FIG. 4.

FIG. 6 shows an overview of a number of profiles connected by a corner piece according to the present invention.

FIG. 7 shows a schematic overview of the device according to the present invention.

### DETAILED DESCRIPTION OF THE INVENTION

Prior art methods comes with the disadvantage that the assembly of a frame must be carried out over several phases, providing time for the glue to dry. For instance, in a first phase, a first set of corner pieces are glued into associated profiles. For instance, in a first phase, the first legs of pairs of first corner pieces are glued into the respective ends of first rectilinear profiles so as to yield a set of prepared profiles with a corner piece glued into each of their ends. The glue must then dry for the profiles to be attached to the corner pieces. Then, in a second phase, the frame must be assembled using the dried glued prepared profiles, and a frame is assembled by means of two prepared profiles, wherein second profiles are glued between two opposing prepared profiles by gluedly sliding the second legs of the pairs of corner pieces into the prepared profiles and gluing them into the mounting channels of the second profiles, after which the frame thus obtained needs to dry again. In this final step, a tensioning belt is also tightened around the frame so as to assure that the frame retains the desired shape during drying.

However, such a method comes with the disadvantage that two drying periods must be taken into account for manufacturing the frame, a first drying period for allowing the corner pieces to dry inside the first profiles and a second drying period for allowing the assembled frames to dry. Moreover, applying and removing the tensioning belts requires additional operations which in turn take up more time.

Although one could consider eliminating the first drying period by omitting it and proceeding directly to the assembly of the frame by means of four profiles and four corner pieces, this has the effect that the resulting frame is too unstable before drying and as a result usually does not assume the desired shape after drying.

It is therefore an aim of the present invention to provide a corner piece that allows a frame to be formed in a stable manner in a shorter time.

The corner piece according to the present invention is thereto characterized in that at least the first leg comprises at least one protrusion which is arranged to extend along a height direction of the mounting channel, so that when sliding the first leg into the mounting channel of the first profile, the profile clamps the first leg into a predetermined position in the mounting channel of the first profile.

Such a corner piece offers the advantage that when mounting the first leg of the corner piece into the mounting channel of the first profile, the profile is clamped into a predetermined position. Clamping the profile in the predetermined position allows the first drying period to be eliminated, making it possible to proceed directly to, for instance, mounting the second leg of the corner piece into the second profile, for instance by gluing. It was found that such a protrusion makes it possible to still provide the connection between the profile and the corner piece with sufficient stability, especially when the first leg is also glued into the mounting channel of the first profile. In other words, the corner piece provided with the protrusion allows a corner element, and thus a frame, to be manufactured in a shorter time.

It was also found that such a protrusion makes it possible to mount the first leg of the corner piece into the mounting channel of the first profile in a single movement, namely, by sliding the first leg up to the predetermined position in the mounting channel.

Moreover, in many cases the corner piece can be provided internally inside the profile, for instance by providing the mounting channel on the inside of the profile, so that the external appearance of the corner element, and therefore also of the frame comprising said corner profile, is not affected by the presence of the corner piece, which is often important for stands, where appearance matters greatly. This means that the corner piece allows, for instance, mounting two or more profiles together while the use of additional, often externally visible mounting means, such as for example welding seams or bolts, can be omitted or even eliminated.

Moreover, it was found that the use of this protrusion even allows the gluing of the legs of the corner piece into the respective profiles to be eliminated altogether, and that a sufficient attachment of the legs in the respective profiles can be achieved, so that drying times as a whole no longer apply.

The invention also relates to a profile, wherein the profile comprises a first mounting channel, with the first mounting channel extending along a first direction, in this case preferably the length direction of the profile, wherein the first mounting channel is arranged to at least partially surround a first leg of a corner piece. The profile comprises at least one protrusion in the first mounting channel. The protrusion may be arranged in the profile by, for instance, punching or alternative methods or by affixing an element to a profile, in ways known to the person skilled in the art, wherein the element comprises the protrusion. The first leg is clamped into the first mounting channel in the predetermined position by means of the protrusion. Preferably, the protrusion slopes downward in the first direction. Preferably, the profile presents a triangular cross section.

The invention also relates to a set comprising the corner piece and at least two profiles, or a corner piece, wherein the corner piece comprises at least a first and a second leg, mounted together at an angle to each other and extending along a first and a second direction, respectively, and at least two profiles, at least one of which being according to the present invention, or the corner piece according to the present invention and at least two profiles, at least one of which being according to the present invention, wherein a first profile of the set comprises a first mounting channel and a second profile of the set comprises a second mounting channel, the first and the second mounting channel extending along the first and the second direction, respectively, wherein the first mounting channel is arranged to at least partially surround the first leg of the corner piece so that the first leg is clamped in the first mounting channel in the predetermined position by means of the protrusion, and wherein the second mounting channel is arranged to at least partially surround the second leg of the corner piece.

Preferably, the material of the profiles does not deform when clamping the legs of the corner piece in the respective profiles, so that the appearance of the profiles is not affected, the corner piece being deformed instead, for instance by inward resilient deformation of the protrusion, preferably when the corner piece is made of steel.

The invention also relates to a corner element comprising at least two profiles connected at an angle by means of the corner piece according to the invention, or at least two profiles connected at an angle by means of a corner piece, at least one of which being according to the present invention, wherein the corner piece comprises at least a first and a second leg, mounted together at an angle to each other and extending along a first and a second direction, respectively, or at least two profiles connected at an angle by means of a corner piece according to the present invention, at least one of which being according to the present invention, wherein the first profile comprises a first mounting channel and the second profile comprises a second mounting channel, the first and the second mounting channel extending along the first and the second direction, respectively, wherein the first mounting channel at least partially surrounds the first leg of the corner piece and wherein the second mounting channel at least partially surrounds the second leg of the corner piece, and wherein the first leg is clamped in the first mounting channel in the predetermined position by means of the protrusion.

According to embodiments of the present invention, the second leg is clamped in the second mounting channel in the predetermined position by means of the at least one subsequent protrusion. Providing subsequent protrusions on the second leg also allows a clamping of the second leg inside the second profile, similar to the clamping of the first leg inside the first profile.

According to embodiments of the present invention, the corner element is a miter joint of the two profiles. Such a miter joint offers the advantage of being deemed more esthetically pleasing, which is particularly deemed important when using the corner element.

According to embodiments of the present invention, at least one of the profiles of the corner element is provided with at least one opening which extends through the profile. One or more such openings allow the weight of the profiles to be reduced without significantly affecting the sturdiness of the profile. Moreover, the openings can be used for attaching several profiles, for instance profiles of different frames, to each other in different ways. It also becomes possible to affix, for instance, panels, curtains, lighting and other decorations. An example of the use of such openings is for instance described in DE202005002572 U1.

According to embodiments of the present invention, the first and/or the second profile is made of metal, for instance of aluminum. According to alternative embodiments, the first and/or the second profile is made of plastic.

According to embodiments of the present invention, the first leg is glued into the first mounting channel and/or the second leg is glued into the second mounting channel. It was found that a glued mounting of the first and/or the second leg into the first en/or second mounting channel, preferably the first and the second leg into the first and second mounting channel respectively, yields a good mounting of the corner piece to the respective profiles, and thus of the profiles to each other.

The invention also relates to a frame comprising the corner element according to the present invention.

According to embodiments of the present invention, the frame comprises at least four, preferably four, corner elements according to the present invention, interconnected by means of four profiles.

The invention also relates to a stand construction element wherein the stand construction element is the frame according to the present invention.

The invention also relates to a stand comprising the stand construction element according to the present invention.

The invention also relates to a method for manufacturing the corner element according to the present invention, wherein the first leg is slid into the first mounting channel along the first direction and the second leg is slid into the second mounting channel along the second direction, and wherein the protrusion clamps the first leg in a predetermined position inside the first mounting channel of the first profile.

According to embodiments of the present invention, the first leg is glued into the first mounting channel.

According to embodiments of the present invention, the subsequent protrusion clamps the second leg in a predetermined position inside the second mounting channel of the second profile.

According to embodiments of the present invention, the second leg is glued into the second mounting channel.

According to embodiments of the present invention, the glue is applied to a side facing away from the protrusion and/or from the subsequent protrusion of the respective leg on which said protrusion is located. It was found that with such an application of the glue an improved gluing is realized, as the corner piece and the protrusion are mutually pressed together by the protrusion. It was also found that a smaller quantity of glue suffices to still achieve a sufficiently strong connection between the corner piece and the respective profiles. In such an embodiment, the glue may for instance be applied directly onto the corner piece, or it may be applied onto the parts of the profile that contact or will contact with the side facing away from the protrusion and/or from the subsequent protrusion of the respective leg on which said protrusion is located, for instance parts of the respective mounting channel.

The invention also relates to a device for implementing the method according to the invention, wherein the device comprises a compression mechanism for sliding the first leg along the first direction into the first mounting channel and the second leg along the second direction into the second mounting channel, and wherein the protrusion clamps the first leg in a predetermined position inside the first mounting channel of the first profile. By providing such a device, the manufacturing of the corner element according to the present invention can be sped up even more, and the connection between the corner piece and the profiles can be made even more rigid since, for instance by applying a predetermined force while sliding the legs of the corner piece into the respective mounting channels, a stronger corner element can be obtained.

According to embodiment examples of the present invention, the compression mechanism comprises a first guiding element for guiding the first leg and/or profile, and a second guiding element for guiding the second leg and/or profile, while sliding the first and second profile relative to the corner piece. Such a configuration allows greater control while manufacturing the corner element, allowing further control over the strength of the corner element.

According to embodiment examples of the present invention, the first and/or second guiding element comprises at least one wheel for rolling guidance of the respective leg and/or profile. As such a wheel rollingly guides the respective leg, scratches on the corner element and/or the profile are avoided, preventing loss of strength and, in the case of avoiding scratches to the profile, deterioration of its appearance.

According to embodiments of the present invention, the device comprises a compression frame for manufacturing and enclosing a frame according to the present invention, wherein the compression frame comprises a respective compression mechanism for the respective corner elements of the frame. It was found that such a mechanism allows speedier manufacturing of the frame according to the present invention.

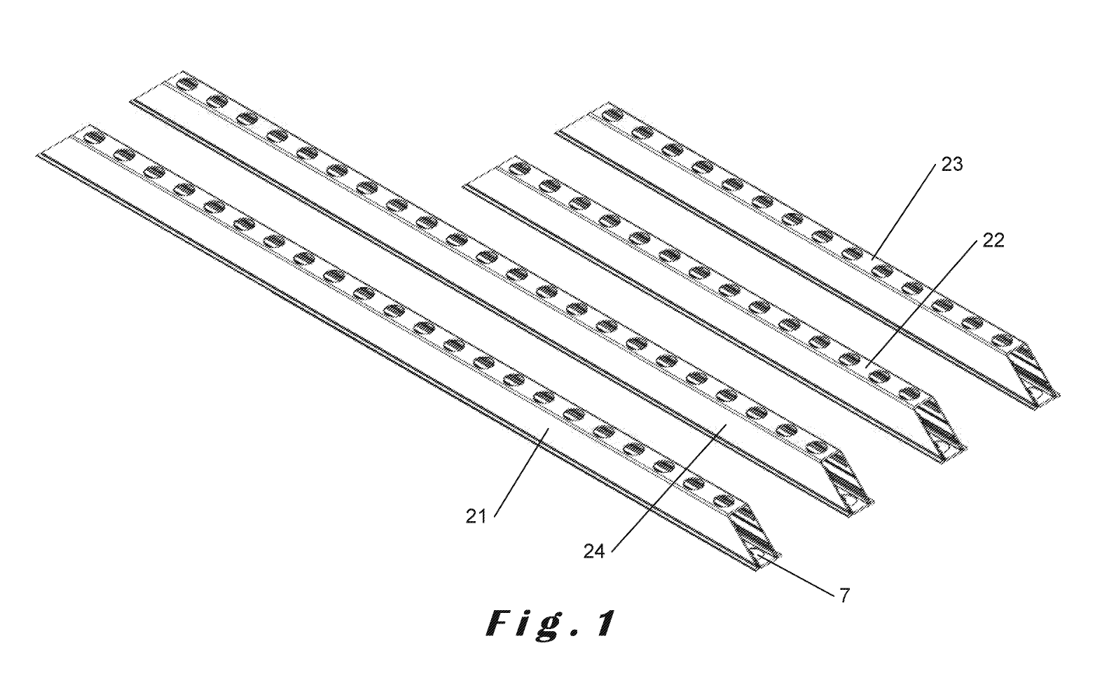

The profiles shown in FIG. 1, preferably made of metal, more preferably of aluminum, are well known to the person skilled in the art, are already commonly in use for the construction of stands, and are currently marketed by, for instance, the Belgian company ALUVISION.

Such profiles are used for manufacturing frames, and said frames are in turn used for constructing stands, wherein the frames constitute the stand construction elements. For interconnecting the different frames, among other things, the profiles are provided with openings 7 extending through the profiles.

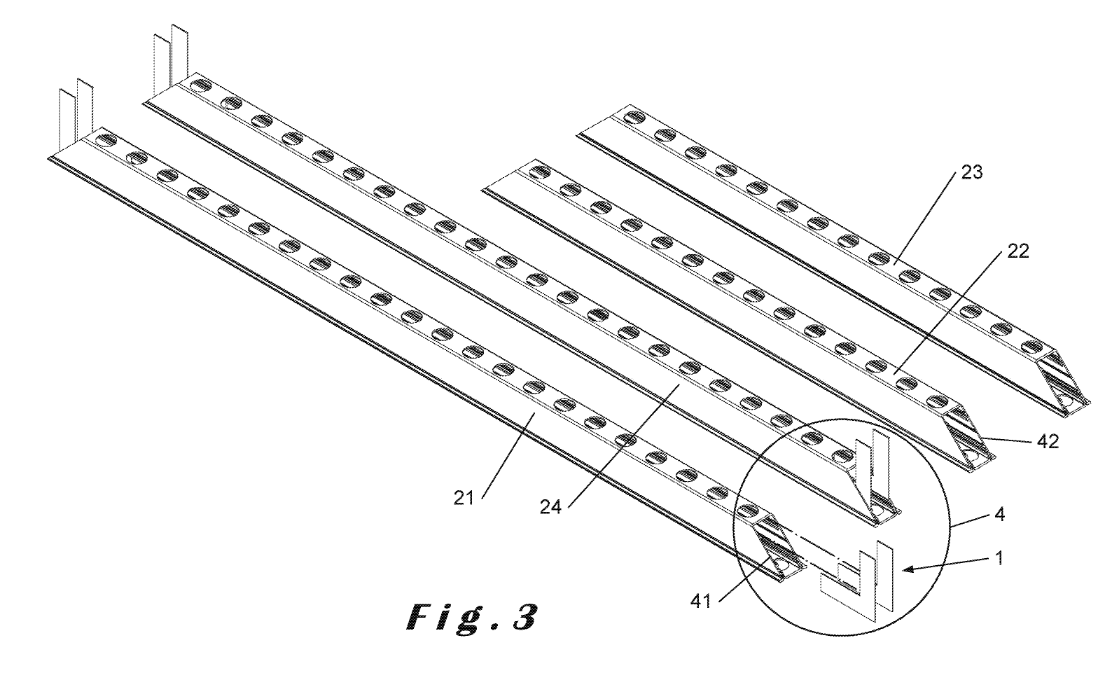

FIG. 3 shows the different profiles of FIG. 1, wherein in some profiles 21, 24 a number of corner pieces 1 according to the present invention have been mounted.

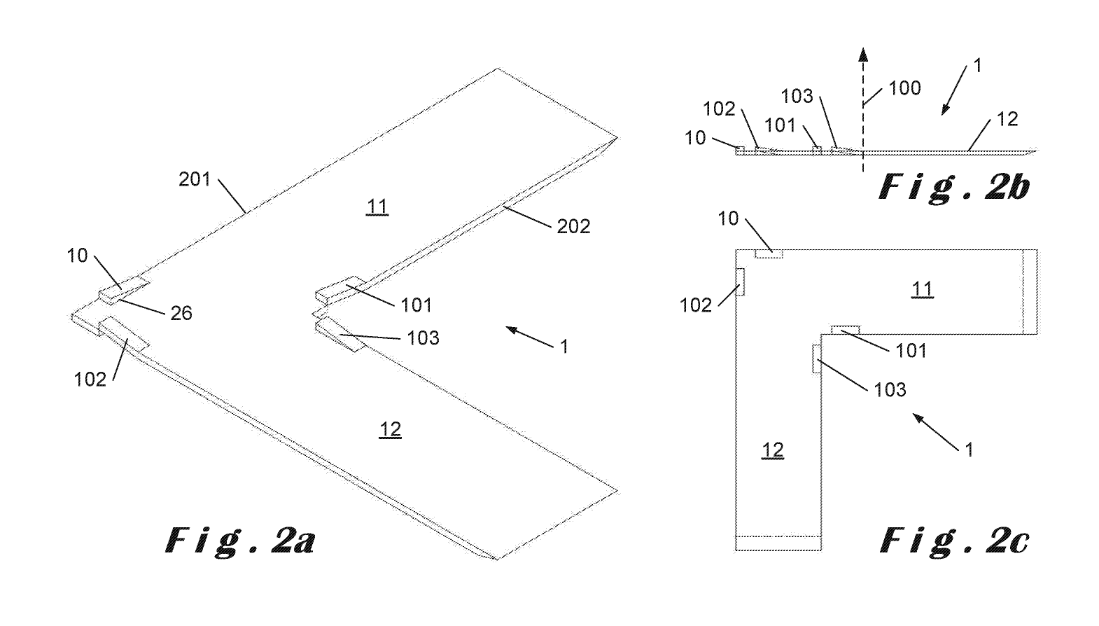

The corner piece 1 according to the present invention is arranged for mounting two profiles 21, 22, 23, 24 at an angle, and is shown in more detail in FIGS. 2a, 2b and 2c. The corner piece 1 comprises at least a first 11 and a second 12 leg. The first and the second leg 11, 12 are mounted together at an angle to each other. The first leg 11 extends along a first direction 31 and the second leg 12 extends along a second direction 32. The first leg 11 is arranged be slid into a mounting channel 41 of a first profile 21 along the first direction 31 and the second leg 12 is arranged to be slid into a mounting channel 42 of a second profile 22 along the second direction 32.

Although the corner piece 1 shown in FIGS. 2a, 2b and 2c comprises two legs 11, 12, the corner piece 1 may also comprise more than two legs. Thus, it is possible for the corner piece to for instance comprise, three legs, for instance to form a corner in three dimensions, or to comprise four legs to form a cross-shaped element, etc.

FIGS. 2a, 2b and 2c further show for example that in the corner piece 1, the first leg 11 is substantially flat and is delimited in the width direction 200 by at least to opposing edges 201, 202 which define the length direction 203 of the first leg 11 and extend along the first direction 31. Furthermore, FIGS. 2a, 2b and 2c also show that the second leg 12 is substantially flat and is limited in the width direction by at least two opposing edges which define the length direction of the second leg 12 and extend along the second direction 32.

However, such a configuration is not necessary for the present invention, and the first and the second leg may also be provided as non-flat, rectangular elements. The shape and dimensions of the first and the second leg 11, 12 are primarily determined by the shape and dimensions of the profiles 21, 22, 23, 24, and furthermore by the shape and dimensions of the mounting channels 41, 42.

As further shown in FIGS. 2a, 2b and 2c, the first and second leg 11, 12 of the corner piece 1, and more preferably the whole corner piece, are in sheet form. Such an embodiment allows the corner piece to be for instance cut, stamped, punched, etc. from a sheet, making the corner piece 1 relatively easy to manufacture.

Preferably, the first leg 11 and/or the second leg 12 of the corner piece 1, preferably the entire corner piece 1, is made from a metal, preferably a resilient metal, more preferably steel.

Preferably, the corner piece 1 is generally symmetrical in shape, for instance with an axis of symmetry where the first 11 and the second 12 leg meet, and the first 11 and the second 12 leg are for instance substantially equal in shape and dimensions, as shown in FIG. 2c. Such an embodiment is of course not necessary for the present invention, and the legs 11, 12 may also be unequal in shape and/or dimensions.

As can be seen in the FIGS. 2a, 2b and 2c, the legs 11, 12 are arranged in an angle of substantially 90° to each other. Such a configuration is, however, not necessary for the present invention, as the angle may be determined by the person skilled in the art depending on the desired configuration, and may for instance also be smaller or greater than 90°, such as for instance 45°, 135°, 180°, etc.

The shape and dimensions of the corner piece 1 may further also be determined by the person skilled in the art as a function of the configuration of the finished corner element 3, for instance partly determined by the dimensions of the corner element, the forces the corner element needs to withstand, etc.

As discussed above, at least the first leg 11 preferably comprises at least one protrusion 10. Although not shown in the figures, the at least one protrusion 10 may also be provided in a profile in a mounting channel. However, by providing the protrusion 10 on the corner piece, the existing profiles can be used without adaptations in combination with the corner piece according to the present invention.

The protrusion 10 is arranged to extend along a height direction 100 of the mounting channel 41, so that when sliding the first leg 11 into the mounting channel 41 of the first profile 21, the profile 10 clamps the first leg 11 in a predetermined position in the mounting channel 41 of the first profile 21.

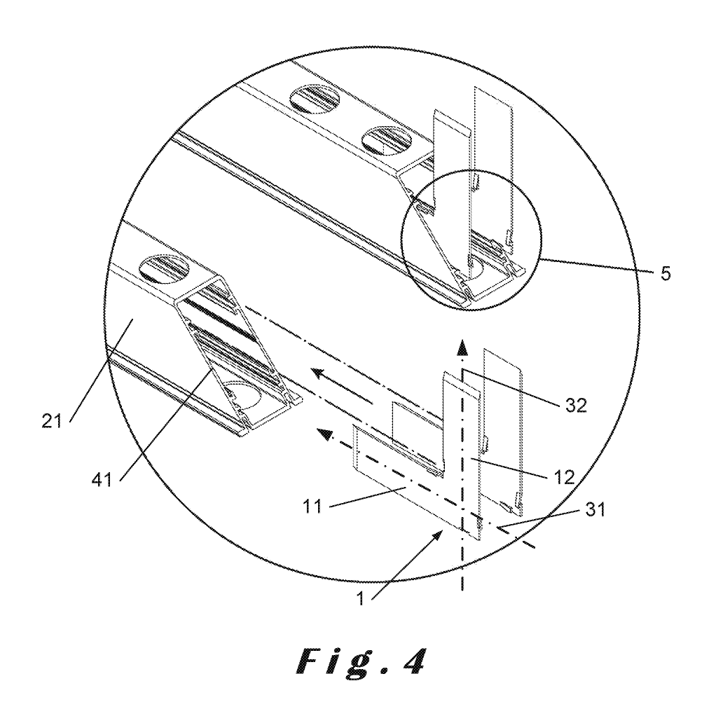

FIG. 2b shows, as an example, the height direction 100 along which the protrusion 10 should extend to allow clamping of the first leg 11 in the mounting channel 41 of the first profile 21. The height direction 100 according to FIG. 4, for instance, extends along a direction substantially perpendicular to the corner piece 1, which is substantially flat.

The protrusion 10 shown in FIG. 2a slopes downward in the first direction 31. However, such a configuration is in no way necessary for the present invention, and the protrusion 10 may for instance also take the form of a sudden elevation in the first leg 11.

As shown in FIG. 2a, the protrusion 10 preferably has a triangular cross-section. The cross-section of the protrusion 10 is of course not limited to such a shape, and other shapes are also suitable for the cross-section of the protrusion 10. Thus, the cross-section of the protrusion 10 may for instance also have another shape, such as for instance a rectangular shape, a semi-circular shape, etc.

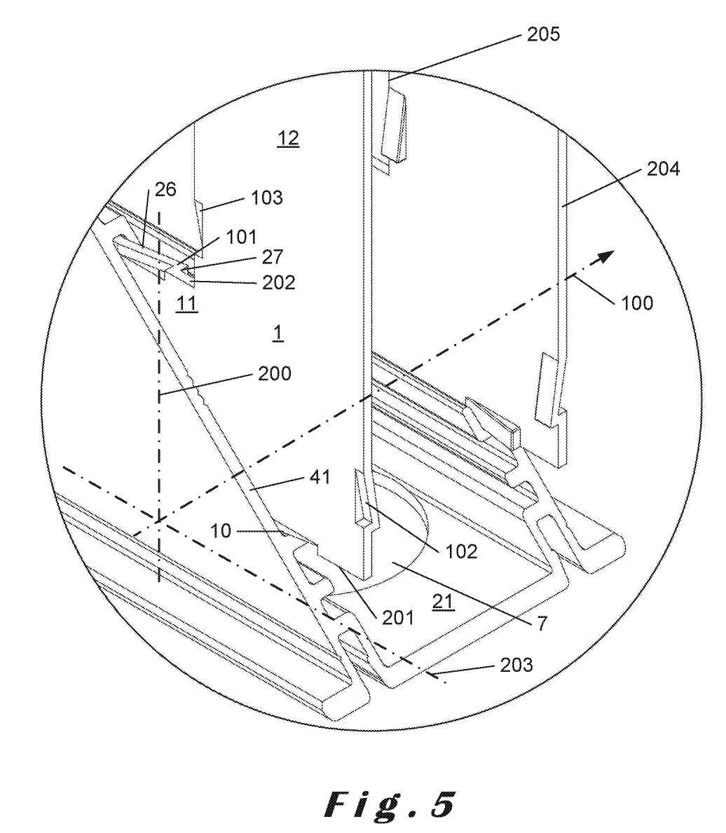

The triangular shape of the cross-section of the protrusion 101 is for instance shown in FIG. 5 and comprises a downward sloping side 26 and a side 27 which from the apex of the downward sloping side 26 again extends toward the rest of the first leg 11. However, the side 27 is not necessary for the present invention and may also be omitted, as is for example shown in FIG. 2a, without thereby eliminating the triangular character of the cross-section of the protrusion 10. Moreover, such a shape offers the advantage that, by omitting the side 27, the downward sloping side 26 may gain further resilience.

As shown in FIG. 2a, the protrusion 10 preferably extends from one of the edges 201 of the first leg 11. Although FIG. 2a shows the protrusion 10 extending from an outer edge of the first leg 11, this is not necessary for the present invention, and the protrusion 10 may also extend from another edge of the first leg 11, for instance an inner edge 202, like for instance the subsequent protrusion 101, which is otherwise preferably similar to the protrusion 10.

As mentioned just above, the corner piece 1 may indeed also comprise subsequent protrusions 101, 102, 103, as shown in FIG. 2a. The subsequent protrusions 101, 102, 103 may be located in any place deemed suitable by the person skilled in the art, and may likewise have any dimension and shape deemed suitable by the person skilled in the art.

As may be seen in FIG. 2a, it is preferred for the subsequent protrusions 101, 102, 103 to be substantially similar in shape and dimension to the protrusion 10, so that a more homogenous clamping of the protrusion in the corresponding mounting channels may be achieved.

The subsequent protrusions 101, 102, 103 may be located on the same leg 11 and/or on the second leg 12. Preferably, the corner piece 1 comprises at least one subsequent protrusion 102, 103 on the second leg 12. More preferably, the corner piece 1 comprises further protrusions 101, 102, 103 on the first leg 11 and on the second leg 12. More preferably, as shown in FIG. 2a, the protrusions 10, 101 on the first leg 11 and the protrusions 102, 103 on the second leg 12 are also mirrored with respect to the axis of symmetry where the first leg 11 and the second leg 12 meet, so as to allow a more homogenous clamping.

As shown in FIG. 2a, the subsequent protrusion 102, 103 present on the second leg 12 may for instance, as shown in FIG. 2a, extend in the height direction of the second leg 12. As shown in FIG. 2a, the at least one subsequent protrusion 102, similar to the protrusion 10 present on the first leg 11, preferably also extends from one of the edges 204, 205 of the second leg 12. Furthermore, also similar to the protrusions 10 and 101 present on the first leg 11, FIG. 2a also shows that the second leg 12 preferably comprises at least two subsequent protrusions 102, 103, and FIG. 2a further shows that the first subsequent protrusion 102 preferably extends from a first edge 204 of the second leg 12 and the second subsequent protrusion 103 extends from a second edge 205 of the second leg 12, wherein the second edge 205 of the second leg 12 is located opposite the first edge 204 of the second leg 12.

As shown in FIG. 2a, the first leg 11 of the corner piece 1 comprises at least one subsequent protrusion 101. The configuration shown in FIG. 2a is such that the protrusion 10 extends from a first edge 201 of the first leg 11 and the subsequent protrusion 101 extends from a second edge 202 of the first leg 11, wherein the second edge 202 of the first leg 11 is located opposite the first edge 201 of the first leg 11.

As mentioned above, the protrusion 10, 101, 102, 103 is preferably triangular in shape, wherein the side 27 has been omitted, and the protrusion 10 further preferably extends from an edge. It was found that in such a configuration, such a protrusion 10 may be manufactured by providing a cut which extends from the edge, and then folding up a part of the leg 11, 12 located along the edge. It was found that such a manufacturing method can be implemented with relative ease.

FIG. 2b further shows that the legs 11, 12 are also preferably tapered along the first and second directions 31, 32, respectively. Although FIG. 2a shows both legs 11, 12 being tapered along the first and second direction 31, 32, respectively, this is not necessary for the present invention, and fewer or even more legs, depending on the number of legs comprised by the corner piece 1, may be tapered. Thus, for instance, only the first leg 11 or the second leg 12 may be tapered, depending on the configuration desired by the person skilled in the art. Furthermore, as shown in FIG. 2a, the side facing away from the protrusion 10, 101, 102, 103 is preferably shorter than the opposite side.

FIGS. 3 and 4 show, by way of example, a set of a profile with a number of corner pieces 1 according to the invention. FIG. 4, for instance, shows two profiles, of which a first is being fitted with corner pieces according to the invention and a second has already been fitted with corner pieces according to the present invention. For clarity, the reference numbers were only added on a first corner piece in FIG. 4 and FIG. 5.

FIGS. 3 and 4 show, by way of an example, the mounting channels 41 present in the profiles 21, 22, 23 and 24. However, the mounting channels are also already known to the person skilled in the art. It is also shown, for instance, that the profiles 21, 22, 23 and 24 comprise two mounting channels 41 along opposing sides of the mounting channels.

Furthermore, FIG. 5 shows a detail of a corner element 3 according to the present invention. The corner element comprises at least two profiles 21, 22, connected at an angle by means of the corner piece 1. The first profile 21 comprises a first mounting channel 41 and the second profile 22 comprises a second mounting channel 42. The first and the second mounting channel 41, 42 extend along the first and the second direction 31, 32, respectively. The first mounting channel 41 at least partially surrounds the first leg 11 of the corner piece 1. The second mounting channel 42 at least partially surrounds the second leg 12 of the corner piece 1. The first leg 11 is clamped in the first mounting channel 41 in the predetermined position by means of the protrusion 10.

FIG. 5 further also shows that, preferably, a corner piece 1 is provided in each mounting channel, so as to strengthen the later mounting of the different profiles to each other.

FIG. 6 further shows that the second leg 12 is clamped in the second mounting channel 42 in the predetermined position by means of the at least one subsequent protrusion 102, 103.

Furthermore, FIG. 6 shows that the corner element is preferably a miter joint of the two profiles 21, 22.

The first leg 11 is for instance glued into the first mounting channel 41, and/or the second leg 12 is glued into the second mounting channel 42. The gluing is not necessary for the present invention and the type of glue, when used, may be determined by the person skilled in the art, wherein the glue should of course be suited for gluing the materials of the profiles and the material of the corner piece 1. Thus, the glue is for instance suited for affixing steel to aluminum.

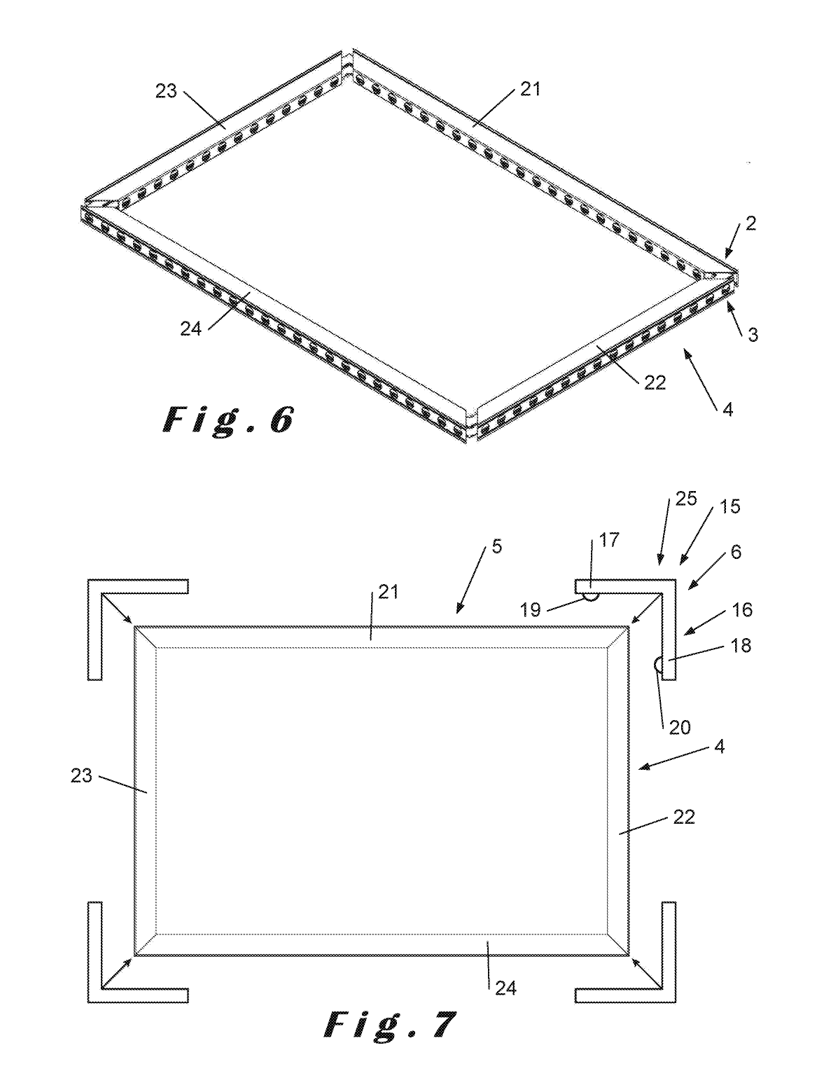

FIGS. 6 and 7 show the frame 4 according to the present invention. The frame 4 for instance comprises four corner elements 3 according to the present invention; the frame 4 may of course comprise more or fewer corner elements, depending in part on the shape of the corner piece 1.

The frame 6 shown in the FIGS. 6 and 7 thus forms a stand construction element which may further be used in the construction of stands in the manner known to the person skilled in the art, so as to obtain the desired stands.

The invention also relates to a method for manufacturing the corner element 3 according to the present invention. In the method according to the invention, the first leg 11 of the corner piece 1 is preferably slid into the first mounting channel 41 along the first direction 31, as shown in FIG. 4. The second leg 12 is similarly slid into the second mounting channel 42 along the second direction 32. In the end, the protrusion 10 clamps the first leg 11 in a predetermined position in the first mounting channel 41 of the first profile 21.

As it is often required for the profiles 21, 22, 23, 24 to form a nicely finished corner element, the profiles are preferably mitered in a first phase, as shown in FIG. 1.

As already mentioned above, the first leg 11 is preferably glued into the first mounting channel 41. 11

As mentioned above, the subsequent protrusion 101 will preferably also clamp the second leg 12 in a predetermined position in the second mounting channel 42 of the second profile 22, and/or the second leg 12 is preferably also glued into the second mounting channel 42. The glue is in that case preferably applied to a side facing away from the protrusion 10 and/or from the subsequent protrusion 10 of the respective leg 11, 12 on which said protrusion 10 is located. Preferably, the glue is for instance applied directly in the respective mounting channels, whereupon by inserting the respective legs of the corner piece 1 the glue is transferred and applied to the afore-mentioned sides of the respective legs.

The invention also relates to a device 6 for implementing the method according to the invention. The device 6 thereto for instance comprises a compression mechanism 16 for sliding the first leg 11 along the first direction 31 into the first mounting channel 41 and the second leg 12 along the second direction 32 into the second mounting channel 42. The protrusion 10 clamps the first leg 11 in a predetermined position inside the first mounting channel 41 of the first profile 21.

This device 6 is for instance shown in FIG. 7. Thus, for instance, the frame 4, half mounted as shown in FIG. 6, is placed into the device 6, whereupon the device 6 further slides the first 11 and second 12 legs in the respective mounting channels 41, 42. By using such a mechanized mounting of the corner pieces 1 and the profiles 21, 22, 23, 24, an increased clamping force caused by the protrusions 10, 101, 102, 103 may be achieved, allowing for less or even no glue to be used.

The compression mechanism 16 comprises a first guiding element 17 for guiding the first leg 11 and/or profile 21, and a second guiding element 18 for guiding the second leg 12 and/or profile 22 while sliding the first and second profile 21, 22 relative to the corner piece 1. The compression mechanism shown in FIG. 7 for instance comprises corner-shaped elements 15, for instance a corner-shaped element 15 for every corner element 3, provided for clasping around the corner elements 3 and comprising the first and second guiding elements 17, 18, respectively. The device 6 is for instance arranged to move the respective guiding elements 17, 18 of, for instance, the respective corner-shaped elements 15 toward each other until the profiles 21, 22 and the corner pieces 1 are brought into the desired position with respect to one another. Thereto, it is for instance possible to provide four movably arranged corner-shaped elements 15, as shown in FIG. 7. This is however not necessary for the present invention, and the device 6 may also for instance comprise a fixed corner-shaped element, in relation to which the other three move, and/or may comprise several corner-shaped elements 15.

Preferably, the first and/or the second guiding element 17, 18 comprises at least one wheel 19, 20 for rollingly guiding the respective leg 11, 12 and/or profile 21, 22.

Preferably, the device 6 comprises a compression frame 25 for manufacturing and enclosing a frame 4. The compression frame 25 comprises a respective compression mechanism 16 for the respective corner elements 3 of the frame 4. The compression frame 25 as shown in FIG. 7 is, for instance, made up of four corner-shaped elements 15.

If glue was used in connecting the different corner pieces 1 and the respective profiles, the frame 4 may further dry after clamping the corner pieces 1 together with the respective profiles, without any need for further operations.

1-40. (canceled)

41. A corner piece for mounting two profiles at an angle, the corner piece comprising:
at least a first leg;
a second leg, wherein the first and the second leg are mounted together at an angle to each other and the first leg extends along a first direction and the second leg extends along a second direction;
wherein the first leg is arranged to be slid into a mounting channel of a first profile along the first direction and the second leg is arranged to be slid into a mounting channel of a second profile along the second direction;
at least the first leg comprising at least one protrusion which is arranged to extend along a height direction of the mounting channel, so that when sliding the first leg into the mounting channel of the first profile, the profile clamps the first leg into a predetermined position in the mounting channel of the first profile.

42. The corner piece according to claim 41, wherein the protrusion slopes downward in the first direction.

43. The corner piece according to claim 42, wherein the protrusion has a triangular cross-section.

44. The corner piece according to claim 41, wherein the first leg is substantially flat and is delimited in its width direction by at least two opposing edges defining the length direction of the first leg and extending along the first direction, wherein the protrusion extends in the height direction of the first leg.

45. The corner piece according to claim 44, wherein the protrusion extends from one of the edges of the first leg.

46. The corner piece according to claim 41, wherein the corner piece comprises at least one subsequent protrusion.

47. The corner piece according to claim 45, wherein the first leg comprises at least one subsequent protrusion.

48. The corner piece according to claim 47, wherein the protrusion extends from a first edge of the first leg and the subsequent protrusion extends from a second edge of the first leg, wherein the second edge of the first leg is located opposite the first edge of the first leg.

49. The corner piece according to claim 46, wherein the second leg comprises at least one subsequent protrusion.

50. The corner piece according to claim 49, wherein the second leg is substantially flat and is delimited in its width direction by at least two opposing edges defining the length direction of the second leg and extending along the second direction.

51. The corner piece according to claim 50, wherein the at least one subsequent protrusion extends in the height direction of the second leg.

52. The corner piece according to claim 51, wherein the at least one subsequent protrusion extends from one of the edges of the second leg.

53. The corner piece according to claim 52, wherein the second leg comprises at least two subsequent protrusions.

54. The corner piece according to claim 53, wherein a first subsequent protrusion extends from a first edge of the second leg and a second subsequent protrusion extends from a second edge of the second leg, wherein the second edge of the second leg is located opposite the first edge of the second leg.

55. The corner piece according to claim 54, wherein the at least one of the first leg tapers along the first direction, and the second leg tapers along the second direction;
wherein the side facing away from the protrusion is shorter than the opposite side.

56. The corner piece according to claim 55, wherein at least one of the first leg and the second leg is formed from steel.

57. The corner piece according to claim 56, wherein the steel at least one of the first leg and the second leg is in sheet form.

58. A profile, comprising:
a first mounting channel extending along a first direction, wherein the first mounting channel is arranged to at least partially surround a first leg of a corner piece; and
at least one protrusion in the first mounting channel, configured wherein the first leg is clamped into the first mounting channel in the predetermined position by means of the protrusion.

59. The profile according to claim 58, wherein the protrusion slopes downward in the first direction.

60. The profile according to claim 59, wherein the protrusion has a triangular cross-section.
